(19) United States
(12) Patent Application Publication
(10) Pub. No.: US 2025/0125476 A1
(43) Pub. Date: Apr. 17, 2025

(54) TRACTION BATTERY PACK ASSEMBLING METHOD

(71) Applicant: Ford Global Technologies, LLC, Dearborn, MI (US)

(72) Inventors: Matthew J. Mahler, Royal Oak, MI (US); Marc Dugas, Wixom, MI (US); Eid Farha, Ypsilanti, MI (US); Brad Warren Probert, Farmington Hills, MI (US); Victor Martinez, Novi, MI (US); Kelsey Mc Comb, Wixom, MI (US)

(21) Appl. No.: 18/484,778

(22) Filed: Oct. 11, 2023

(51) Int. Cl. H01M 50/291; B60L 50/64; H01M 10/6554; H01M 50/209; H01M 50/242; H01M 50/264; H01M 50/293; H01M 50/502

(52) U.S. Cl. CPC H01M 50/291; B60L 50/64; H01M 10/6554; H01M 50/209; H01M 50/242; H01M 50/264; H01M 50/293; H01M 50/502; H01M 2220/20

(57) ABSTRACT

A method of assembling a traction battery includes holding a plurality of battery cells, positioning at least one shim next to the plurality of battery cells, and sandwiching the at least one shim between the plurality of battery cells and a thermal exchange plate. The at least one shim maintains a space between the thermal exchange plate and the plurality of battery cells. The method further includes bonding the thermal exchange plate to the plurality of battery cells using a thermal interface material.

### TECHNICAL FIELD

This disclosure relates generally to electrified vehicle traction battery packs and, more particularly, to assembling the battery packs.

### BACKGROUND

A traction battery pack of an electrified vehicle can include groups of battery cells arranged in one or more battery arrays. An enclosure can house the battery arrays. The battery cells can expand over time.

### SUMMARY

In some aspects, the techniques described herein relate to a method of assembling a traction battery, including: holding a plurality of battery cells; positioning at least one shim next to the plurality of battery cells; sandwiching the at least one shim between the plurality of battery cells and a thermal exchange plate, the at least one shim maintaining a space between the thermal exchange plate and the plurality of battery cells; and bonding the thermal exchange plate to the plurality of battery cells using a thermal interface material.

In some aspects, the techniques described herein relate to a method, wherein the at least one shim directly contacts the plurality of battery cells and the thermal exchange plate after the bonding.

In some aspects, the techniques described herein relate to a method, further including securing the at least one shim to the plurality of battery cells using an adhesive.

In some aspects, the techniques described herein relate to a method, further including depositing the thermal interface material on the plurality of battery cells prior to sandwiching the at least one shim between the thermal exchange plate and the plurality of battery cells.

In some aspects, the techniques described herein relate to a method, further including holding the plurality of battery cells within a fixture.

In some aspects, the techniques described herein relate to a method, wherein each battery cell within the plurality of battery cells is spaced a distance from other battery cells within the plurality of battery cells to provide a gap between each of the battery cells within the plurality of battery cells.

In some aspects, the techniques described herein relate to a method, wherein the at least one shim spans over the gap.

In some aspects, the techniques described herein relate to a method, wherein each battery cell within the plurality of battery cells includes a terminal side and a bottom side that is opposite the terminal side, the shim and the thermal interface material interfacing directly with the bottom sides of the battery cells within the plurality of battery cells.

In some aspects, the techniques described herein relate to a method, wherein the terminal sides face vertically downward during at least the positioning and the sandwiching.

In some aspects, the techniques described herein relate to a method, further including securing the terminal sides of the battery cells to a busbar module.

In some aspects, the techniques described herein relate to a method, further including rotating the plurality of battery cells together with the busbar module, the at least one shim, and the thermal exchange plate, and, after the rotating, inserting the plurality of battery cells, the busbar module, and the thermal exchange plate into an enclosure structure.

In some aspects, the techniques described herein relate to a method, wherein the terminal sides face vertically upward after the rotating.

In some aspects, the techniques described herein relate to a method, further including, prior to the inserting, binding the plurality of battery cells to constrain expansion.

In some aspects, the techniques described herein relate to a method, wherein the binding includes wrapping tension straps about at least a portion the plurality of battery cells.

In some aspects, the techniques described herein relate to a traction battery assembly, including: a plurality of battery cells disposed along an axis, each of the battery cells within the plurality of battery cells spaced a distance from other battery cells within the plurality of battery cells to provide an gap between each of the battery cells within the plurality of battery cells; a thermal exchange plate; a thermal interface material bonding the plurality of battery cells to the thermal exchange plate; and at least one shim sandwiched between the thermal exchange plate and the plurality of battery cells, the at least one shim configured to maintain a space between the thermal exchange plate and the plurality of battery cells.

In some aspects, the techniques described herein relate to an assembly, wherein the at least one shim is nylon.

In some aspects, the techniques described herein relate to an assembly, further including an adhesive that secures the at least one shim to the plurality of battery cells.

In some aspects, the techniques described herein relate to an assembly, wherein the at least one shim spans the gap between each of the battery cells within the plurality of battery cells.

In some aspects, the techniques described herein relate to an assembly, further including a busbar module secured to the plurality of battery cells on a side of the plurality of battery cells opposite the thermal exchange plate.

In some aspects, the techniques described herein relate to an assembly, further including at least one tension strap extending alongside the plurality of battery cells, the at least one tension strap constraining expansion of the plurality of battery cells.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The various features and advantages of this disclosure will become apparent to those skilled in the art from the following detailed description. The drawings that accompany the detailed description can be briefly described as follows.

FIG. 1 schematically illustrates an electrified vehicle.

FIG. 2 is a perspective partially expanded and partially sectioned view of a battery pack from the electrified vehicle of FIG. 1.

FIG. 3 is a close up view of an example battery cell from the battery pack 14 of FIG. 2.

FIGS. 4-15 illustrate steps in an exemplary method of assembling the traction battery of FIG. 2 with elements simplified for clarity.

### DETAILED DESCRIPTION

This disclosure details exemplary traction battery pack designs for use in electrified vehicles. Exemplary traction battery packs can include an enclosure assembly establishing an interior, and at least one battery array housed within the interior. These and other features are discussed in greater detail in the following paragraphs of this detailed description.

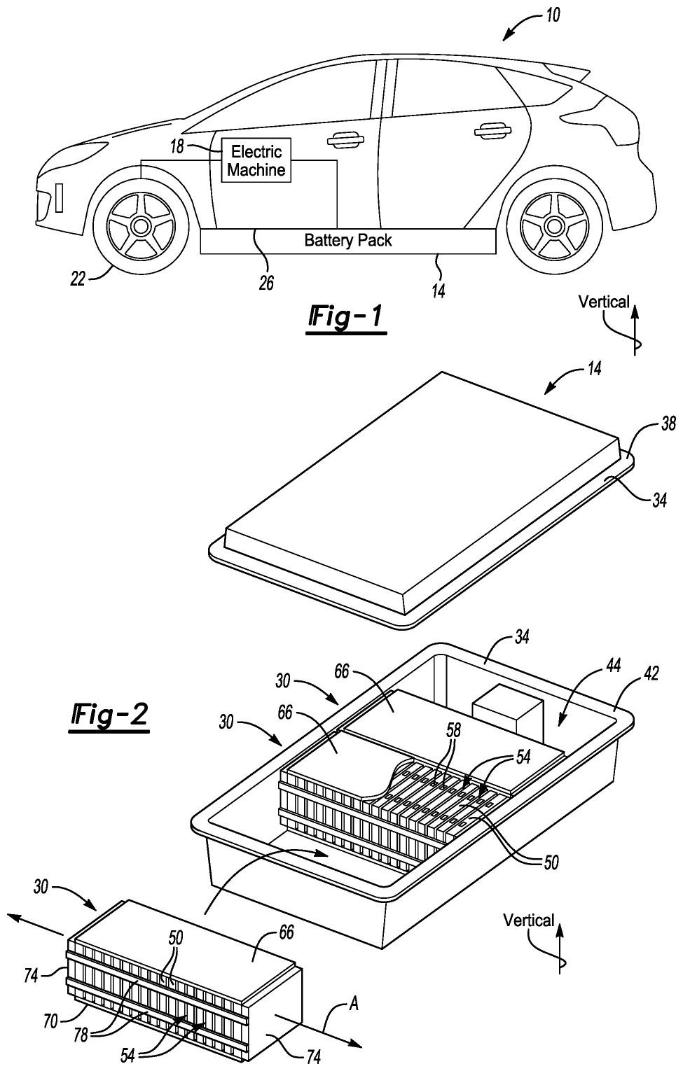

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

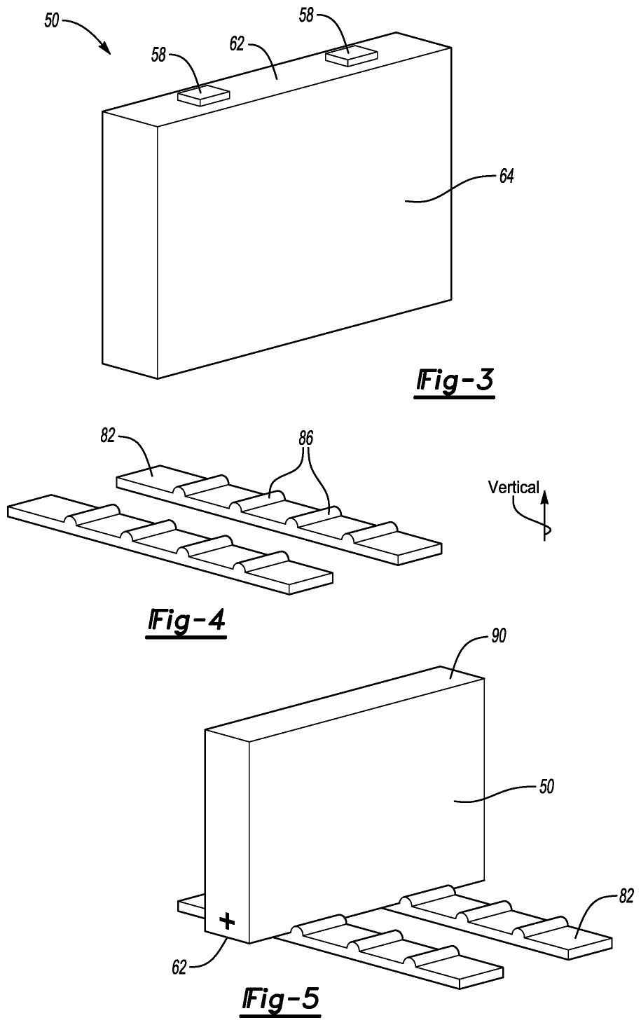

With reference now to FIGS. 2 and 3, the battery pack 14 includes a plurality of battery arrays 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the battery arrays 30. The enclosure cover 38 can be secured to the enclosure tray 42 using mechanical fasteners (not shown), for example.

Each of the battery arrays 30 includes, among other things, a plurality of battery cells 50 (or simply “cells”) disposed side-by-side relative to each along a respective battery array axis A. In this example, the axes A of the battery arrays 30 are parallel to each other and extend longitudinally in a cross-vehicle direction.

The battery cells 50 store and supply electrical power. Although a specific number of the battery arrays 30 and cells 50 are illustrated in the various figures of this disclosure, the battery pack 14 could include any number of the battery arrays 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure.

Notably, the battery cells 50 are spaced a distance from each other such that there are gaps 54 between the cells 50. The gaps 54 provide space for the battery cells 50 to expand a bit as the battery pack 14 is used within the vehicle 10. The gaps 54 can be from 2.0 to 3.0 millimeters.

Each of the example battery cells 50 includes a pair of terminals 58 extending from a side 62 of an outer case 64, which is metal in this example. The sides 62 including the terminals can be considered terminal sides. In this example, when installed within the battery pack 14, the sides 62 face vertically upward. Vertical, for purposes of this disclosure, is with reference to ground and a general orientation of the vehicle 10 during operation.

Within each of the battery arrays 30, the individual battery cells 50 can be electrically connected together. To establish these electrical connections, the terminals 58 of the example battery cells 50 are electrically connected to a busbar module 66.

The battery cells 50 within each of the arrays 30 are disposed atop a thermal exchange plate 70. Thermal energy within the cells 50 and surrounding areas of the battery pack 14 can be managed using the thermal exchange plate 70. In an example, a coolant cab be circulated through the thermal exchange plate 70 to take on thermal energy from the cells 50 and cool the cells 50 during operation.

At the axial ends of the arrays 30 are endplates 74, which are considered “megabars” in some examples. At least one tension strap 78 extends along opposing sides of the arrays 30 and joins together the endplates 74. In this example, the tension straps 78 are wrapped around the arrays 30 help to hold the axial positions of the endplates 74 to help constrain expansion of the cells and focus expansion of the cells 50 into the gaps 54 rather than along the axis A into the enclosure tray 42. In this example, the endplates 74 are each associated with a single one of the arrays 30. In another example, the endplates 74 could span across two or more of the arrays 30.

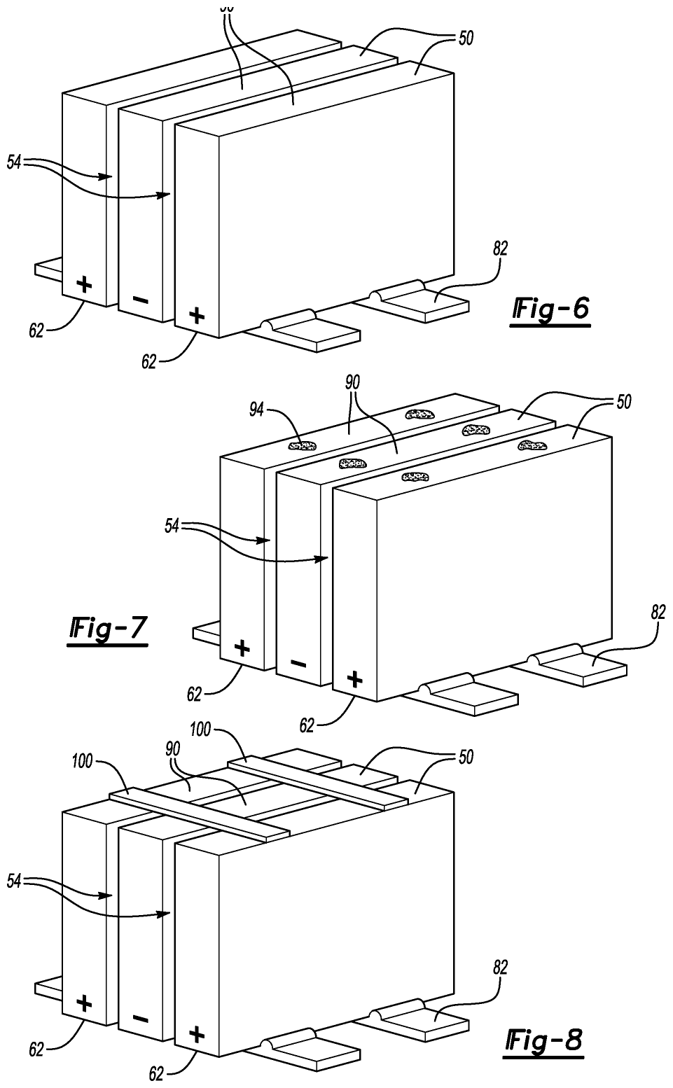

An exemplary method of assembling one of the arrays 30 will now be described with reference now to FIGS. 4-15. For clarity, the array 30 is represented with three of the battery cells 50. As shown in FIG. 2, the array 30 can include more battery cells 50.

When assembling the array 30, individual cells 50 are placed upon a fixture 82 as shown in FIGS. 4-6. The fixture 82 includes features 86, here ribs, that help align the individual cells 50 relative to one another to provide the desired gaps 54 between the cells 50.

Notably, the cells 50 are placed on the fixture 82 such that the sides 62 face vertically downward, and the bottom sides 90 of the cells 50 face vertically upward. In this position, the cells 50 are 180° offset from how the battery cells 50 will ultimately be arranged within the assembled battery pack 14.

With reference to FIG. 7, after arranging the cells 50 upon the fixture 82, dollops of adhesive 94 are deposited on the bottom sides 90 of the cells 50.

Next, as shown in FIG. 8, shims 100 are secured to the bottom sides 90 using the adhesive 94. The shims 100 span the gaps 54 between the cells 50. The shims 100 directly contact the bottom sides 90 of the cells 50. The shims 100 can, at this stage of assembly, help to maintain spacing between the cells 50 and thus the gaps 54. The shims 100 can be non-metal and fairly rigid. In some examples, the shims 100 are strips of nylon material. The shims can be 0.5 millimeters thick in some examples.

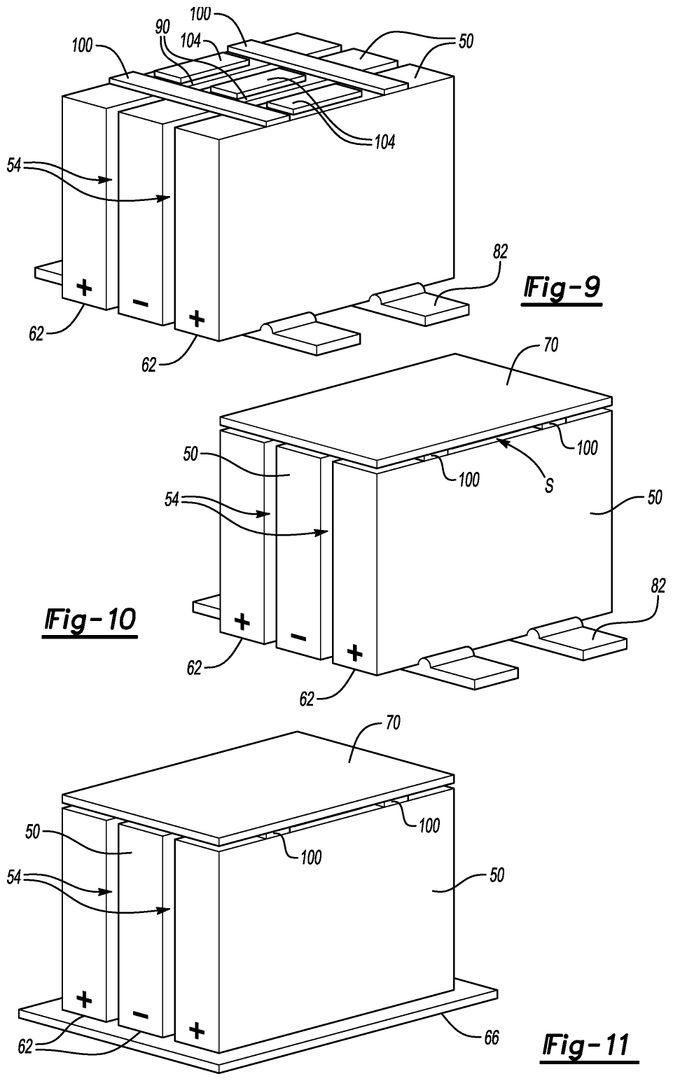

As shown in FIG. 9, thermal interface material (TIM) 104 is then deposited on the bottom side 90 of the cells 50. In this example, the TIM 104 is deposited between the shims 100.

With reference to FIG. 10, the thermal exchange plate 70 is then positioned on the battery cells 50 before the TIM 104 has cured. The thermal exchange plate 70 is positioned such that the TIM 104 is sandwiching the shims 100 between the bottom sides 90 of the battery cells 50 and the thermal exchange plate 70.

The shims 100 maintain a space S between the thermal exchange plate 70 and the bottom sides 90 of the cells 50. In this example, the space is 0.5 millimeters because the shims 100 are 0.5 millimeters thick. Maintaining the space S provides space for the TIM 104 to cure without being squeezed out from between the thermal exchange plate 70 and the cells 50. This ensures that enough of the TIM 104 remains for bonding and eventual thermal transfer within the battery pack 14. After the TIM 104 cures, the TIM 104 fills areas between the thermal exchange plate 70 and the cells 50 and bonds the thermal exchange plate 70 to the bottom sides 90 of the cells 50. The TIM 104 can help to electrically isolate areas of the battery pack 14.

Next, with reference to FIG. 11, the fixture 82 is removed and the cells 50 are positioned on the busbar module 66 such that the busbar module 66 is opposite the thermal exchange plate 70. The bonds between the cells 50 and the thermal exchange plate 70 as well as the bond between the cell 50 and the shims 100 can maintain the positions of the cells 50 during this step. After positioning the busbar module 66, the terminals 58 of the battery cells 50 are electrically coupled to the busbar module 66.

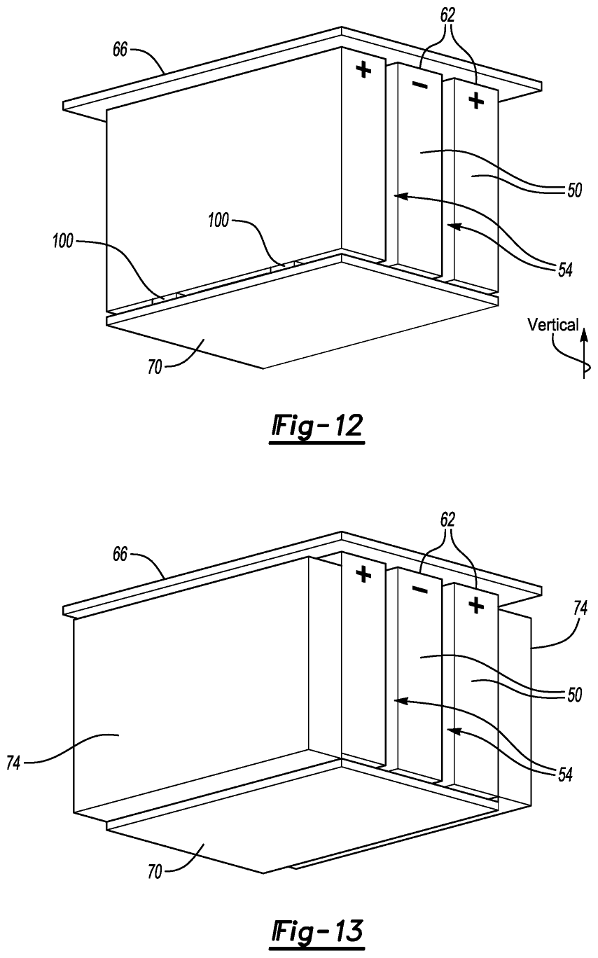

The battery cells 50 together with the busbar module 66, the shims 100, and the thermal exchange plate 70 are the rotated 180 degrees into the position of FIG. 12. This flips the battery cells 50 such that the sides 62 face vertically upward and the bottom sides 90 face vertically downward.

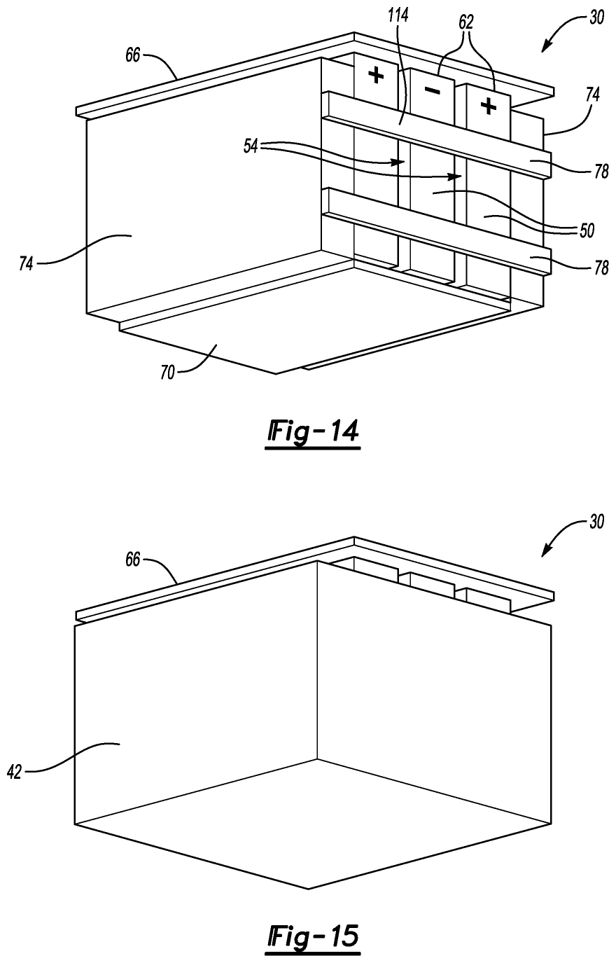

The endplates 74 are then then positioned against the battery cells 50 as shown in FIG. 13. Next, as shown in FIG. 14, tension straps 114 are attached to the endplates 74. At this point, the array 30 is assembled. The array 30 can then be positioned within the enclosure tray 42 as shown in FIG. 15.

The example array 30 in FIGS. 4-15 is represented by three cells 50 but, as mentioned previously, the array 50 could include several more cells 30.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method of assembling a traction battery, comprising:
holding a plurality of battery cells;
positioning at least one shim next to the plurality of battery cells;
sandwiching the at least one shim between the plurality of battery cells and a thermal exchange plate, the at least one shim maintaining a space between the thermal exchange plate and the plurality of battery cells; and
bonding the thermal exchange plate to the plurality of battery cells using a thermal interface material.

2. The method of claim 1, wherein the at least one shim directly contacts the plurality of battery cells and the thermal exchange plate after the bonding.

3. The method of claim 1, further comprising securing the at least one shim to the plurality of battery cells using an adhesive.

4. The method of claim 1, further comprising depositing the thermal interface material on the plurality of battery cells prior to sandwiching the at least one shim between the thermal exchange plate and the plurality of battery cells.

5. The method of claim 1, further comprising holding the plurality of battery cells within a fixture.

6. The method of claim 1, wherein each battery cell within the plurality of battery cells is spaced a distance from other battery cells within the plurality of battery cells to provide a gap between each of the battery cells within the plurality of battery cells.

7. The method of claim 6, wherein the at least one shim spans over the gap.

8. The method of claim 1, wherein each battery cell within the plurality of battery cells includes a terminal side and a bottom side that is opposite the terminal side, the shim and the thermal interface material interfacing directly with the bottom sides of the battery cells within the plurality of battery cells.

9. The method of claim 8, wherein the terminal sides face vertically downward during at least the positioning and the sandwiching.

10. The method of claim 9, further comprising securing the terminal sides of the battery cells to a busbar module.

11. The method of claim 10, further comprising rotating the plurality of battery cells together with the busbar module, the at least one shim, and the thermal exchange plate, and, after the rotating, inserting the plurality of battery cells, the busbar module, and the thermal exchange plate into an enclosure structure.

12. The method of claim 11, wherein the terminal sides face vertically upward after the rotating.

13. The method of claim 11, further comprising, prior to the inserting, binding the plurality of battery cells to constrain expansion.

14. The method of claim 13, wherein the binding comprises wrapping tension straps about at least a portion the plurality of battery cells.

15. A traction battery assembly, comprising:
a plurality of battery cells disposed along an axis, each of the battery cells within the plurality of battery cells spaced a distance from other battery cells within the plurality of battery cells to provide an gap between each of the battery cells within the plurality of battery cells;
a thermal exchange plate;
a thermal interface material bonding the plurality of battery cells to the thermal exchange plate; and
at least one shim sandwiched between the thermal exchange plate and the plurality of battery cells, the at least one shim configured to maintain a space between the thermal exchange plate and the plurality of battery cells.

16. The assembly of claim 15, wherein the at least one shim is nylon.

17. The assembly of claim 15, further comprising an adhesive that secures the at least one shim to the plurality of battery cells.

18. The assembly of claim 15, wherein the at least one shim spans the gap between each of the battery cells within the plurality of battery cells.

19. The assembly of claim 15, further comprising a busbar module secured to the plurality of battery cells on a side of the plurality of battery cells opposite the thermal exchange plate.

20. The assembly of claim 15, further comprising at least one tension strap extending alongside the plurality of battery cells, the at least one tension strap constraining expansion of the plurality of battery cells.
